(19) United States
(12) Patent Application Publication
(10) Pub. No.: US 2006/0236879 A1
(43) Pub. Date: Oct. 26, 2006

(54) Spring-assisted embossing seal

(75) Inventor: Steven J. Sculler, Morganville, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: M&R Marking Systems, Inc., Piscataway, NJ (US)

(21) Appl. No.: 11/385,618

(22) Filed: Mar. 21, 2006

Related U.S. Application Data
(60) Provisional application No. 60/664,128, filed on Mar. 22, 2005.

(51) Int. Cl. B44B 5/00

(52) U.S. Cl. 101/31.1

(57) ABSTRACT

An embossing seal includes a frame, a die exposed at an underside of the frame, and a handle connected to the frame, the handle being movable between an extended position and a depressed position. The embossing seal includes an impact element movable from a first position in contact with the die to a second position spaced from the die, and a spring coupled with the impact element for normally urging the impact element into the first position, the spring being deflectable for storing energy. The embossing seal also has a lever linking the handle to the impact element. In operation, movement of the handle from the extended position toward the depressed position causes the lever to move the impact element from the first position to the second position for deflecting and storing energy in the spring. Further movement of the handle toward the depressed position causes the lever to release the impact element so that the energy stored in the deflected spring is transferred to the impact element for moving the impact element back to the first position so that the impact element strikes the die with a striking force.

### CROSS-REFERENCE

The present application claims the benefit of U.S. Provisional Application No. 60/664,128, filed Mar. 22, 2005, the disclosure of which is hereby incorporated by reference herein.

### FIELD OF THE INVENTION

The present invention relates to embossing seals and more particularly relates to mechanically assisted embossing seals.

### BACKGROUND OF THE INVENTION

For many years, seals have been placed on documents to verify their authenticity. One of the earliest seals was created by placing wax on a document and then pressing the face of a ring into the wax. When the document was later presented to a third party, the authenticity of the document was verified by analyzing the image or symbol formed in the wax. Today, seals are created using a press-like device that stamps an image onto a document. Such seals are generally found on government documents such as birth certificates, death certificates and marriage licenses, as well as other documents such as architectural drawings and notarized documents.

Most conventional embossing seals have a die and an opposing counter that move toward one another for forming an image on an article. On the die, the image is depressed from a generally planar surface. The counter also has an image, which mirrors the image that is on the stamping die. The die and the counter can be made using a variety of methods that are well known to those skilled in the art. Typically the die and counter are arranged so that the image created on the document can be read from left to right. In the alternative, the image can be produced so that it can be read from left to right from the debossed side of the document.

In order to place a seal on a document, the item is placed between the die and the counter. The die and counter are then moved toward one another until the opposing elements are separated by only the thickness of the document. Further movement of the die and the counter toward one another results in the raised image on the counter forcing a portion of the article into the depressed image on the die. At maximum pressure, the raised image on the counter and the depressed image on the die are fully engaged with the article for selectively stretching and depressing the image onto the article. If the pressure applied is sufficient to cause the material of the article to stretch or yield, a permanent, precisely formed, raised image will result on one side of the article. The opposite side of the article will have a debossed mirror image of the raised image.

An embossed or debossed image can be formed on almost any type of flexible, deformable material. At one end of the spectrum, the deformable material may made of metal such as a malleable metal sheet or a metal block. At the other end of the spectrum, the deformable material may be gossamer-like paper. As noted above, the most common articles to be embossed include commercial paper stock used for legal documents, architectural or engineering drawings, government documents, letterhead, envelopes and the like.

There are generally two types of embossing seals: desk seals and pocket seals. Desk seals are typically large, ornate devices that are designed to both impress the observer and to effectively impress a seal onto a document. Size and portability are not major concerns with desk seals. As a result, mechanical features such as levers can be added to a desk seal to make the stamping procedure easier for an operator, without concern for the overall size or weight of the device.

The second type of seal, a pocket seal, offers the same functionality as desk seals, but in a more compact design. As the term suggests, pocket seals are small enough to fit inside a typical pocket. Pocket seals may also be small enough to fit within a briefcase, a pocketbook, or a three-ring binder. Because of their portability, pocket seals can be easily transported from one location to another, which provides a distinct advantage over stationary desk seals.

The small size of pocket seals is both an advantage and a drawback. While large desk seals can provide a significant mechanical advantage through various drive mechanisms, the operation of a pocket seal relies primarily on hand strength to create the embossed seal.

As noted above, the paper stock of the document to be sealed can vary greatly in weight and thickness, as well as in fiber type and content. The denser and thicker the paper, the more force that is required to produce an image. As a result, individuals using pocket seals are frequently faced with fatigue and potential repetitive motion injuries from the constant strain placed on the hand and wrist during the operation. Those afflicted with weak hand muscles, arthritis, or other physical ailments will be limited in their use of a conventional pocket seal. Some individuals may be forced into using the more cumbersome, stationary desk seals. In situations where the use of a desk seal is not possible, however, no other option is readily available.

When seals are placed on documents, it may be necessary to position and/or align the seal over a particular region of a document. For example, it may be necessary to place a seal at the bottom edge of a document. If the same seal were used to affix a seal to the top edge of another document, e.g. for letterhead, the image would be inverted. Likewise, if the seal were used on the right-hand edge of a document, the image would be turned 90 degrees from the normal reading position. In either of these two latter conditions, the seal image would be difficult to read.

Conventional pocket seal presses have two opposing arms that are pivotally connected with one another. The two arms are compressible toward one another for moving the sealing ends of the arms toward one another. The die and the counter are typically attached to the opposing arms, at the sealing ends of the respective arms. The die and the counter are normally held apart by one or more springs, which may include one or more leaf springs. The structure of the holder allows the opposing faces of the die and the counter to move normal to one another while preventing the opposing faces from moving parallel to one another. Thus, once the die and the counter are properly oriented and assembled with the holder, the die and counter cannot become misaligned.

With the die and counter thus connected, the one or more leaf springs define a throat that limits how far from the edge of a sheet the seal can be made. If the throat is not deep enough, the pocket seal cannot produce a correct-reading image located at an interior region of the embossed article. Even if a seal press could be built that has a sufficiently deep throat, a deep throat causes a myriad of insurmountable problems with the seal press as well as with the geometry between the die and counter.

Thus, there is a need for a seal that is easy to operate and that reduces the level of manual force required to produce a suitable raised image. There is also a need for an embossing seal having a die and counter that can be positioned in a number of different orientations to allow correctly aligned images to be produced on documents, regardless of the orientation of the seal press relative to the document. There is also a need for an embossing seal with a sufficiently deep throat to allow placement of a seal in an interior region of a document.

There is also a need for a seal that enables the die and the counter to be interchanged so that the counter comes in contact with the face of the document and displaces the article into the engraved areas of the die on the opposite side. By doing so, an image readable from left to right can be formed on the debossed side of the document.

There is also a need for a seal that embosses or debosses images into certain materials that are not in sheet form, such as a block of wood or metal. There is also a need for an embossing seal that can be used to form images on both documents, such as paper documents, and harder items such as metal blocks.

### SUMMARY OF THE INVENTION

In certain preferred embodiments of the present invention, an embossing seal includes a frame, a die exposed at an underside of the frame, and a handle connected to the frame. The handle is desirably movable between an extended position and a depressed position. The embossing seal also desirably includes an impact element movable from a first position in contact with the die to a second position spaced from the die. A spring is preferably coupled with the impact element for normally urging the impact element into the first position, against the die. The spring is preferably deflectable for storing energy. The spring can have any design so long as it is able to store energy and release energy. The spring may include two or more springs in contact with the impact element. The spring may be a coil spring having one or more coils.

The embossing seal also preferably includes a lever linking the handle to the impact element. In operation, movement of the handle from the extended position toward the depressed position causes the lever to move the impact element from the first position to the second position for deflecting and storing energy in the spring. In other preferred embodiments, the handle may incorporate the features found in the lever so that there is not a need for an additional item such as a lever. After the initial downward movement of the handle, further movement of the handle toward the depressed position causes the lever to release the impact element so that the energy stored in the deflected spring is transferred to the impact element for moving the impact element back to the first position against the die. Due to the energy transferred from the spring to the impact element, the impact element strikes the die with a sufficient force to transfer an image from the die to an article abutted against the die.

In certain preferred embodiments, the die may include a die support that is attached to the frame and the die attached to the die support. The die is preferably detachably connected with the frame so that it can be removed from contact with the seal and later re-attached to the seal. In still other preferred embodiments, the angular orientation of the die relative to the frame may be changeable. In highly preferred embodiments, the angular orientation can be set at zero, 90, 180 and 270 degrees. I still other preferred embodiments, the angular orientation can be set at additional angles such as 45 degrees, 225 degrees, etc. In still other preferred embodiments having both a die and a counter, the energy transferred from the impact element to the die presses a seal on an article positioned between the die and the counter. The embossing seal may be a pocket seal or a desk seal. The counter is preferably detachably connected with the base and angularly rotatable relative to the base as described above for the die. The counter may be directly attachable to the base or may be coupled with the base using a counter support.

In certain preferred embodiments, the embossing seal includes a counter opposing the die. The counter and the die are desirably movable toward one another for embossing a seal on an item. The die may have a first image formed thereon and the counter may have a second image formed thereon that is a mirror image of the first image. One of the first and second images is preferably raised and one of the first and second images in preferably depressed. The die and the counter may be rotatable to one or more fixed positions for selectively aligning the first and second images of the respective die and counter with an item placed between the die and the counter. The die and the counter may have alignment tabs provided thereon that may be used to properly align the image with an article, such as a document.

The handle may be pivotally attached to the frame and the frame may be pivotally attached to a base that supports the seal device. In certain preferred embodiments, the spring has a first end connected to the impact element and a second end connected to the frame. The first and second ends of the spring may define a distance that is adjustable for adjusting the tension of the spring and/or the level of energy that may be stored in the spring. In other preferred embodiments, a second spring in contact with the impact element may be added. In still other preferred embodiments, more than two springs may be in contact with the impact element for normally urging the impact element to remain in contact with the die or die support.

The impact element can have any shape and/or size required for effectively transferring energy or striking force from a spring to the die. In certain preferred embodiments, the impact element has a bottom face that is adapted to selectively strike a backside of the die or die support for transferring energy from the impact element to the die. In certain preferred embodiments, the impact element includes an upper end, the bottom face, and a reduced diameter area between the upper end and the bottom face. The reduced diameter may be an undercut area or a neck that defines an upper shoulder and a lower shoulder. The lever desirably includes a tip end that is adapted to engage the reduced diameter area or the upper shoulder of the impact element for selectively moving the impact element away from the die. The lever is preferably adapted to pivot relative to the frame for urging the tip end of the lever into contact with the impact element, and providing leverage as the tip end urges the impact element away from the die.

In certain preferred embodiments, the embossing seal includes a lever return spring in contact with the lever for returning the lever from the depressed position to the extended position. The lever may have a first end including the tip end and a second end remote therefrom. The lever may have a notch adjacent the second end thereof that is adapted to receive the lever return spring.

The embossing seal may also have a base pivotally connected with the frame and a base return spring positioned between the frame and the base for urging the frame from a frame depressed position to a frame extended position.

In still other preferred embodiments of the present invention, an embossing seal includes a frame, a die exposed at an underside of the frame, and a base pivotally connected to the frame, the base including a counter that opposes the die. The embossing seal also desirably includes a handle pivotally connected to the frame, the handle being movable between an extended position and a depressed position, an impact element disposed in the frame and being movable from a first position in contact with the die to a second position spaced from the die, and a spring coupled with the impact element for normally urging the impact element against the die. The spring is preferably deflectable for storing energy. The embossing seal also preferably includes a lever pivotally attached to the frame and linking the handle to the impact element. During operation, initial movement of the handle from the handle extended position toward the handle depressed position causes the lever to lift the impact element away from the die for deflecting and storing energy in the spring that is coupled with the impact element. Further movement of the handle toward the handle depressed position causes the lever to release the impact element, thereby transferring the energy stored in the spring to the impact element for urging the impact element against the die with a striking force.

In certain preferred embodiments, the spring has a first end connected with the impact element and a second end connected with the frame, whereby the spring is deflectable for storing energy therein. The first and second ends of the spring are movable toward one another for adjusting the amount of energy that is storable in the spring.

Although the invention is primarily directed to use in pocket seals, there is also a need for such an effort-saving improvement for desk seals. Repetitive use of these devices can lead to physical strain, fatigue and possible injury. Thus, the present invention is appropriate for use in desk seals as well.

For simplicity, the discussion herein generally refers to the article being embossed as paper. It is understood, however, that the scope of the invention is broadly applicable to any resilient, flexible materials in sheet form. The present invention may also be used to place seals on larger items such as blocks of metal and wood. For these larger items, the base of the embossing seal may be rotated relative to the frame to enable the die to be abutted against a surface of the larger object.

A mechanical advantage may be obtained in the present invention through the use of one or more linkages or levers. In the embossing seal device disclosed in the present application, manual pressure is exerted on the seal press to urge the die and counter elements toward each other. Once the article (e.g. document) is securely pressed between the die and the counter, additional force applied to the seal device begins the embossing process and also begins to raise the impact element against the force of an energy-storing element. In one preferred embodiment, the energy-storing element is a torsion spring. However, the energy-storing element can be any component that effectively stores energy, and then releases energy to the impact element. When the impact element is at a predetermined distance or position relative to the die, the impact element is released for striking an area on the back of the die for imparting a striking force on the die. With appropriately chosen mechanical elements, the impact force delivered may be significantly higher than the force required to load the energy-storing element. In highly preferred embodiments of the present invention, the energy-storing element may be adjusted to selectively control the magnitude of the impact force applied by the impact element. The adjustment feature allows the user to select the force exerted on the document to achieve a desirable image on any type of paper stock or sheet material.

These and other preferred embodiments of the present invention will be described in more detail below.

### BRIEF DESCRIPTION OF THE DRAWINGS

FIG. 1 shows a perspective view of an embossing seal having a depressible handle, in accordance with certain preferred embodiments to the present invention.

FIG. 2A shows a cross sectional view of the embossing seal shown in FIG. 1.

FIG. 2B shows an expanded view of a portion of the embossing seal shown in FIG. 2A.

FIG. 3 shows another cross sectional view of the embossing seal shown in FIG. 1 with the handle being slightly depressed.

FIG. 4 shows a cross sectional view of the embossing seal of FIG. 3 after the handle has been depressed further from the position shown in FIG. 3.

FIG. 5 shows a cross sectional view of the embossing seal of FIG. 4 after the handle has been depressed further from the position shown in FIG. 4.

FIG. 6 shows a cross sectional view of the embossing seal of FIG. 5 after the handle has been depressed further from the position shown in FIG. 5.

FIG. 7 shows a cross sectional view of the embossing seal of FIG. 1 with a base of the seal rotated relative to a frame of the seal.

### DETAILED DESCRIPTION OF PREFERRED EMBODIMENTS

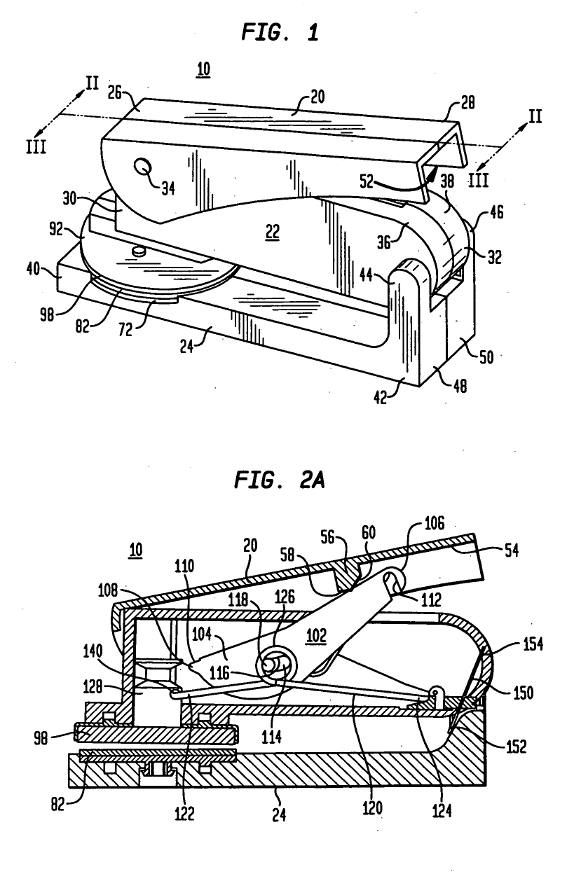

Referring to FIG. 1, in certain preferred embodiments of the present invention, an embossing seal 10 includes a handle 20 that is pivotally connected to a frame 22, which, in turn, is pivotally connected to a base 24. The handle 20 includes a leading end 26 and a trailing end 28 remote therefrom. The frame 22 has a leading end 30 and a trailing end 32 remote therefrom. The leading end 26 of the handle 20 is pivotally connected with the leading end 30 of frame 22 via a pivot element 34. The frame 22 has a first half 36 that may be assembled with a second half 38. The two halves 36, 38 may be assembled using any one of a number of attachment devices such as a tongue-in-groove arrangement, pins insertible into depressions, screws, adhesive, etc.

The base 24 preferably includes a leading end 40 and a trailing end 42 remote therefrom. The trailing end 42 of the base 24 includes a pair of vertically extending legs 44, 46. The base 24 also desirably includes a first half 48 that may be assembled with a second half 50 using the assembly elements described above. In other preferred embodiments, the base may be made of one piece or may be made of two or more pieces that are assembled together.

Any one of the handle 20, the frame 22 and the base 24 may be made from structurally rigid materials such as, structurally rigid plastic resins. In certain preferred embodiments, any one of the handle 20, frame 22 and base 24 components may be made from plastic resins such as polycarbonate, acrylonitrile butadiene styrene (ABS), glass-filled nylon, etc. In still other preferred embodiments of the present invention, the elements may be made from metal or metal alloys.

The pivot element 34 preferably projects from the frame 22, at the leading end 30 of the frame 22 and perpendicular to a longitudinal axis of the frame 22. The pivot element 34 may be a single pin that extends through the frame or may be formed as two components, with each half projecting from one of the halves 36, 38 of the frame 22. A second pivoting element (not shown) is provided at the trailing end 32 of the frame 22 for pivotally connecting the frame 22 to the trailing end 48 of base 24.

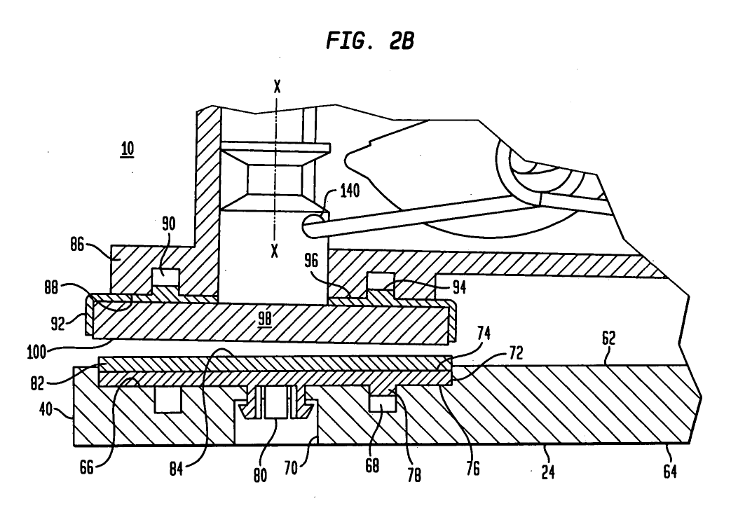

Referring to FIGS. 1 and 2A, handle 20 has a substantially U-shaped underside 52. Referring to FIG. 2A, the inside surface 54 of handle 20 includes a boss 56 projecting therefrom. The boss 56 includes a first surface 58 that extends in a direction substantially parallel to the inside surface 54 of handle 20. The boss 56 also includes a second surface 60 that extends diagonally relative to inside surface 54 and first surface 58.

Referring to FIG. 2B, the base 24 has a top surface 62 and a bottom surface 64. The base may be adapted for sitting atop a flat surface such as a tabletop. In other preferred embodiments, the base may be adapted for engagement by a user's hand. Thus, the seal disclosed in the present application may be a pocket seal or a desk seal. The leading end 40 of the base 24 desirably has a first recess 66 formed in the top surface 62. The recess 66 also includes two or more pockets 68 that extend below the floor of recess 66. The base also desirably includes a second recess 70 that extends from the bottom surface 64 toward the top surface 62. The second recess is preferably centrally located relative to the first recess 66. In other words, the second recess 70 may be located equidistant from the two or more pockets 68.

The embossing seal 10 also desirably includes a counter support 72 having a top surface 74 and a bottom surface 76. The bottom surface 76 includes one or more projections 78 extending therefrom that are adapted to fit within the two or more pockets 68. The bottom surface of the counter support 72 also includes a centrally located anchoring element 80 projecting therefrom. During assembly, the central anchor 80 is received within centrally located second recess 70 and the one or more projections 78 are received within the two or more pockets 68. As a result, the counter support 72 is reliably secured to the base 24. In certain preferred embodiments, the counter support 72 is able to rotate relative to the base after being attached thereto.

The embossing seal 10 also preferably includes a counter 82 that is connected with the counter support 72. The counter 82 has a top face 84 that preferably contains a portion of a seal.

The frame 22 preferably includes a die mounting surface 86 including a die mounting face 88 having die mounting pockets 90 formed therein. The seal 10 also desirably includes a die support 92 having one or more projections 94 formed on a first face 96 thereof. The one or more projections 94 are preferably received within the die mounting pockets 90 for holding the die support 92 affixed to the leading end 30 of the frame 22. Embossing seal 10 also desirably includes die 98 having a face 100 adapted to oppose and abut against the top face 84 of counter 82.

In other preferred embodiments of the present invention, the die is attached directly to the frame and the counter is attached directly to the base. In these particular preferred embodiments, there may be no die support and/or counter support.

In the particular preferred embodiment shown in FIGS. 1, 2A and 2B, the die 98 and counter 82 are circular in shape. In other preferred embodiments, however, the die and counter have other shapes. The die and counter may be rotated so that they can be aligned with an article to be sealed. In certain preferred embodiments, the die and counter can be rotated at zero, 90, 180 and 270 degrees so that the seal image can be properly aligned with a document. The projections 78, 94 on the respective counter support 72 and the die support 92, are preferably received by the pockets 68 and 90, for holding the counter and die at the particular zero, 90, 180 and 270 degree angle selected by a user.

In operation, the projections 78 on the bottom face of the counter support 72 are sized and shaped so that the counter support 72 can be displaced vertically and rotated relative to the base 24 without disengaging the central projection 80 from its attachment to central recess 70. As a result, the counter support 72 is able to rotate relative to the base 24 without becoming disengaged from base 24. The die support can be rotated in a similar manner. The counter and the die may have alignment marks that indicate the angle at which the counter and die have been set. The alignment marks preferably insure that the die and counter are properly aligned with one another and/or the document being sealed.

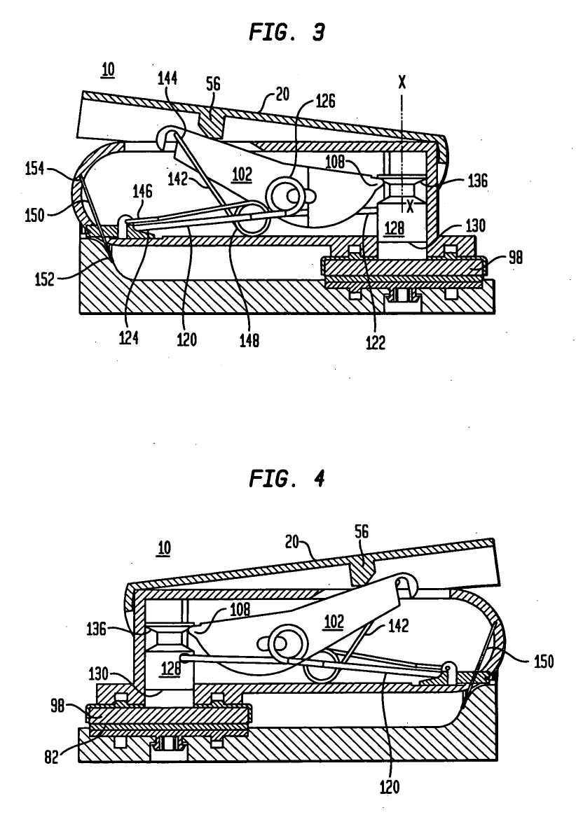

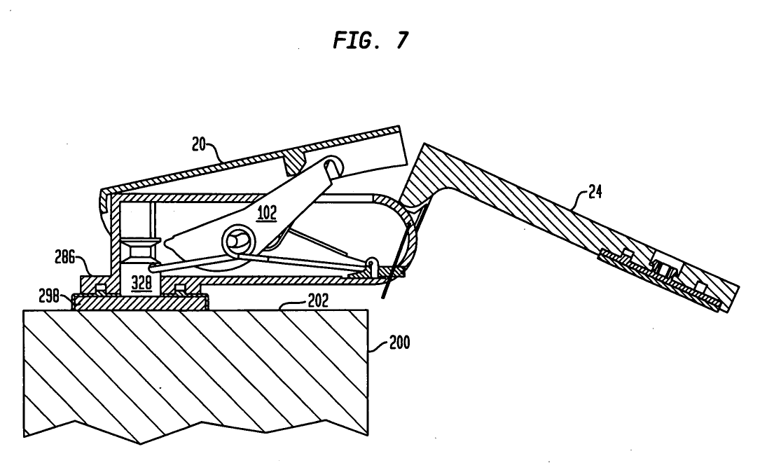

Referring to FIGS. 2A and 3, the embossing seal 10 preferably includes a lever 102 having a leading end 104 and a trailing end 106. The leading end 104 includes a lever tip 108 including a ledge 110 and the trailing end 106 includes a notch 112. The lever 102 also includes a lever slot 114 having elongated sidewalls 116. Embossing seal 10 also preferably includes a lever pivot element 118 that is captured within the lever slot 114. The lever pivot element 118 enables the lever to move between the fully extended position shown in FIG. 2A and a depressed position shown in FIG. 6.

Referring to FIGS. 2A and 3, the embossing seal 10 also preferably includes a torsion spring 120 having a leading end 122 and a trailing end 124. The torsion spring 120 has a center coil 126 that facilitates compression and expansion thereof. The center coil 126 of torsion spring 120 preferably does not engage lever pivot element 118 during operation of the seal.

In certain preferred embodiments, the torsion spring has a pair of leading ends that are spaced from one another and that are connected to the impact element. In other preferred embodiments, the center coil 126 may include two or more coils for increasing the amount of energy that may be stored in the torsion spring. In still other preferred embodiments, a first torsion spring may be provided on one side of the lever and a second torsion spring may be provided on another side of the lever for balancing the forces exerted upon the impact element.

Referring to FIGS. 2A, 2B and 3, embossing seal 10 also preferably includes an impact element 128 having a lower end 130, an upper end 132, and a reduced diameter neck 134 defining an upper shoulder 136 and a lower shoulder 138. The impact element 128 also desirably includes at least one opening 140 (FIG. 2A) that receives at least one leading end 122 of torsion spring 120. The impact element 128 is adapted for sliding movement along a vertical axis designated X-X (FIG. 3).

Referring to FIGS. 2A and 3, the embossing seal 10 also preferably includes a lever return spring 142 having a first end 144 engaging notch 112 of lever 102 and a second end 146 secured to the frame 22 of the seal. The lever return spring 142 also includes one or more center coils 148 that enable the lever return spring to store energy for returning the lever to its original state after being compressed.

Embossing seal 10 also includes a frame return spring 150 having a lower end 152 in contact with base 24 and an upper end 154 in contact with frame 22. The frame return spring 150 is adapted to return the frame to its original idle position after the handle and frame have been depressed.

Referring to FIGS. 2A and 2B, initially the strike face 100 of die 98 is not in contact with the top face 84 of counter 82. In order to form a seal on an item such as a document or sheet, the item is placed between the die 98 and the counter 82. Initially, when the handle is in the extended position shown in FIG. 2A, the lever pivot element 118 is located at the forward end of the slot 114 of lever 102. When downward pressure is applied on the handle 20, the lever 102 is urged forward so that the tip end 108 is urged into contact with the impact element. Referring to FIG. 3, when tip 110 of lever 102 is positioned in engagement with the upper shoulder 136 of impact element 128, the handle may be pivoted downwardly toward base 24. The boss 56 of handle 20 urges the lever 102 to pivot about the lever pivot element 118. Such action causes the tip 108 of the lever 102 to urge the bottom face 130 of the impact element 128 away from the die 98.

Referring to FIG. 4, further downward movement of the handle 20 urges the lever 102 and the tip end 108 of the lever to pivot further. This movement further elevates the bottom face 130 of the impact element 128 above the die 98. As the lever 102 is being pivoted, the torsion spring 120 is being compressed, thereby storing energy in the torsion spring. In addition, compression force is being stored in lever return spring 142. At this point, the energy cannot be released from the springs 120, 142 because the tip end 108 of the lever 102 prevents the impact element 128 from moving back toward the die 98.

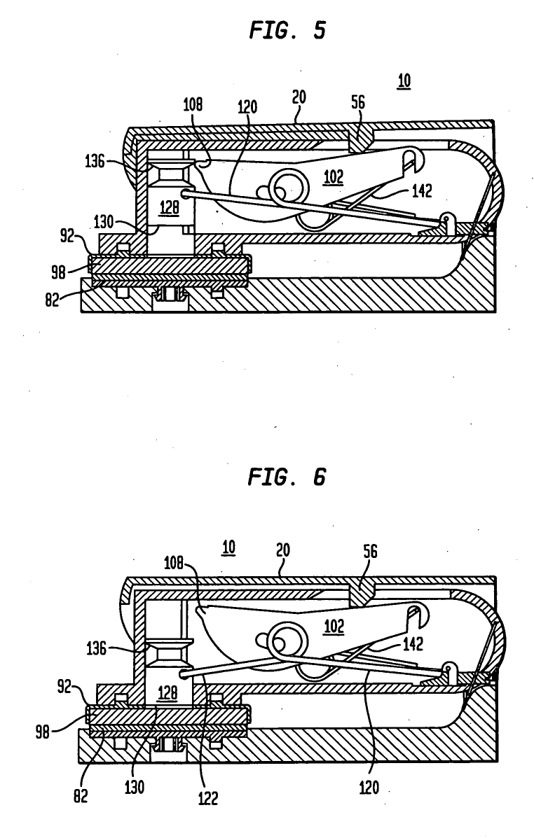

Referring to FIGS. 4 and 5, as the handle is depressed still further, the tip end 108 of the lever 102 moves toward the outer perimeter of the upper shoulder 136 of the impact element 128. During this further movement, additional compression energy is stored in torsion spring 120 and lever return spring 142.

Referring to FIG. 6, after lever 102 pivots even further, the tip end 108 of the lever 102 releases the upper shoulder 136 of the impact element 128. Once the tip end 108 releases the upper shoulder 136, the impact element 128 is free to move downwardly along the axis designated X-X (FIG. 3), due primarily to the energy that has been stored in torsion spring 120. Once the tip end 108 of the lever 102 releases the upper shoulder 136, the torsion spring 120 forces the impact element 128 downwardly toward the die support 92 which transfers the force to the die 98 intimately connected therewith. The force exerted upon the die 98 by the impact element 128 will emboss an item (not shown), such as a paper document, positioned between the die 98 and the counter 82.

After an item has been sealed, the handle 20 can be released. At this time, the lever return spring 42 will release the energy stored therein for moving the handle back to the position shown in FIG. 1. As shown in FIG. 6, the first end 144 of the lever return spring 142 will push upwardly on notch 112 formed at the trailing end 106 of the lever 102, which, in turn, forces the handle to return to the original position shown in FIGS. 1 and 2A. In addition, the frame return spring 150 (FIG. 2A) will transfer stored energy to the frame and the base for returning the frame back to the idle or extended position shown in FIG. 2A.

Referring to FIG. 7, in certain preferred embodiments of the present invention, the item to be embossed may be too large to fit between the frame 22 and the base 24. For example, a seal may have to be placed on a block 200. In this instance, the base 24 may be rotated to the position shown in FIG. 7. After rotating the base 24 to the position shown in FIG. 7, the die 298 may be positioned over a surface 202 of the block 200. The embossing seal may then be operated as described above for forming a seal on the surface 202 of the block 200.

As these and other variations and combinations of the features set forth above can be utilized, the foregoing description of the preferred embodiment should be taken by way of illustration rather than by limitation of the invention.

1. An embossing seal comprising:
a frame;
a die exposed at an underside of said frame;
a handle connected to said frame, said handle being movable between an extended position and a depressed position;
an impact element movable from a first position in contact with said die to a second position spaced from said die;
a spring coupled with said impact element for normally urging said impact element into the first position, said spring being deflectable for storing energy; and
a lever linking said handle to said impact element, wherein movement of said handle from the extended position toward the depressed position causes said lever to move said impact element from the first position to the second position for deflecting and storing energy in said spring, and wherein further movement of said handle toward the depressed position causes said lever to release said impact element so that the energy stored in said deflected spring is transferred to said impact element for moving said impact element back to the first position so that said impact element strikes said die with a striking force.

2. The seal as claimed in claim 1, further comprising:
a counter opposing said die, wherein said counter and said die are movable toward one another for embossing a seal on an item.

3. The seal as claimed in claim 2, wherein said die has a first image formed thereon and said counter has a second image formed thereon that is a mirror image of the first image.

4. The seal as claimed in claim 2, wherein one of the first and second images is raised and one of the first and second images in depressed.

5. The seal as claimed in claim 2, wherein said die and said counter are rotatable to one or more fixed positions for selectively aligning said seal with an item placed between said die and said counter.

6. The embossing seal as claimed in claim 1, wherein said handle is pivotally attached to said frame and said frame is pivotally attached to said base.

7. The embossing seal as claimed in claim 1, wherein said spring has a first end connected to said impact element and a second end connected to said frame.

8. The embossing seal as claimed in claim 1, wherein the first and second ends of the spring define a distance that is adjustable for adjusting the level of energy that may be stored in said spring.

9. The embossing seal as claimed in claim 1, wherein said impact element has a bottom face that is adapted to selectively strike a backside of said die for transferring energy from sad impact element to said die.

10. The embossing seal as claimed in claim 1, wherein said impact element includes an upper end, a lower end, a neck between the upper and lower ends, said neck defining an upper should and a lower shoulder, said lever including a tip end that is adapted to engage the upper shoulder of said impact element for selectively moving said impact element away from said die.

11. The embossing seal as claimed in claim 1, said lever having a tip end and said lever being adapted to pivot relative to said frame for urging the tip end of said lever into contact with said impact element.

12. The embossing seal as claimed in claim 11, further comprising a lever return spring in contact with said lever for returning said lever from the depressed position to the extended position.

13. The embossing seal as claimed in claim 12, said lever having a first end including the tip end and a second end remote therefrom, said lever further comprising a notch adjacent the second end thereof that is adapted to receive the lever return spring.

14. The embossing seal as claimed in claim 1, further comprising a base pivotally connected with said frame and a base return spring positioned between said frame and said base for urging said frame from a frame depressed position to a frame extended position.

15. An embossing seal comprising:
a frame;
a die exposed at an underside of said frame;
a base pivotally connected to said frame, said base including a counter that opposes said die;
a handle pivotally connected to said frame, said handle being movable between an extended position and a depressed position;
an impact element disposed in said frame and being movable from a first position in contact with said die to a second position spaced from said die;
a spring coupled with said impact element for normally urging said impact element against said die, said spring being deflectable for storing energy; and
a lever pivotally attached to said frame and linking said handle to said impact element, wherein initial movement of said handle from the handle extended position toward the handle depressed position causes said lever to lift said impact element away from said die for deflecting and storing energy in said spring.

16. The embossing seal as claimed in claim 15, wherein further movement of said handle toward the handle depressed position causes said lever to release said impact element for transferring energy from said spring to said impact element for urging said impact element against said die with a striking force.

17. The embossing seal as claimed in claim 15, wherein said spring has a first end connected with said impact element and a second end connected with said frame, and wherein said spring is deflectable for storing energy therein.

18. The embossing seal as claimed in claim 17, wherein the first and second ends of said spring are movable toward one another for adjusting the amount of energy that is storable in said spring.

19. The embossing seal as claimed in claim 15, wherein said die has a first image formed thereon and said counter has a second image formed thereon that is a mirror image of the first image.

20. The embossing seal as claimed in claim 19, wherein said die is rotatably connected with said frame and said counter is rotatably connected with said base so that the first and second images can be selectively aligned with an article.
